(19) United States
(12) Patent Application Publication
(10) Pub. No.: US 2017/0352121 A1
(43) Pub. Date: Dec. 7, 2017

(54) METHOD AND SYSTEM OF FACILITATING DRAFTING OF LEGISLATION

(71) Applicant: Morgan Warstler, Austin, TX (US)

(72) Inventor: Morgan Warstler, Austin, TX (US)

(21) Appl. No.: 15/615,495

(22) Filed: Jun. 6, 2017

Related U.S. Application Data
(63) Continuation-in-part of application No. 15/615,443, filed on Jun. 6, 2017.
(60) Provisional application No. 62/346,251, filed on Jun. 6, 2016.
(60) Provisional application No. 62/346,242, filed on Jun. 6, 2016.

(51) Int. Cl. G06Q 50/26; G06F 17/24; G06Q 10/10

(52) U.S. Cl. CPC G06Q 50/26; G06Q 10/101; G06F 17/24; G06Q 10/10

(57) ABSTRACT

Disclosed is a computer method of facilitating drafting of legislation. The method includes receiving a subject indicator from a legislator device. Further, the method includes analyzing the subject indicator. Further, the method includes retrieving a plurality of suggested legal constructs from a storage device based on the analyzing of the subject indicator. Further, the method includes transmitting the plurality of suggested legal constructs to the legislator device. Moreover, the method includes receiving a plurality of selected legal constructs from the legislator device. Further, the method includes analyzing the plurality of selected legal constructs based on a plurality of rules. Further, the method includes generating at least one suggested legislation based on the analyzing of the plurality of selected legal constructs. Further, the method includes storing the at least one suggested legislation in the storage device. Moreover, the method includes transmitting the at least one suggested legislation to the legislator device.

The current application claims a priority to the U.S. Provisional Patent application Ser. No. 62/346,242 filed on Jun. 6, 2016, and to the U.S. Provisional Patent application Ser. No. 62/346,251 filed on Jun. 6, 2016.

### FIELD OF THE INVENTION

The present invention relates to drafting documents. In particular, the present invention relates to a method and a system of drafting legislation.

### BACKGROUND OF THE INVENTION

The laws of man probably existed even before the written language. They certainly existed before universal literacy. The technology to draft laws has evolved from using stones and chisel, to using pen and paper, and now to using computers and bits of data. The advancement in technology has made it easier to draft laws. For example, the 1926 edition of the US Code was one bound volume, but the current 2012 edition is 41 volumes.

Many laws (such as the tax law) are administered by forms submitted by the taxpayer. Similarly, the regulatory law is increasingly being enforced by the collection of government filings (and regulatory fees as well). At all levels of government, much of government is simply processing the paperwork of a citizen who wants permission to do something, such as, driving a car, carrying a pistol, building a house or operating a business.

With modern technology, government agencies have increasingly moved to computerize government filing documents. This approach is beneficial for the environment as fewer trees are needed to print the forms. However, it often complicates the lawmaking process by adding steps to the process. For example, if a county commission enacts a law that says camping on public land is a misdemeanor (or, conversely, simply says that it is always permissible), there is no regulatory paperwork or discretion. If the law says camping is legal upon notifying police department by phone, there is just one regulatory step, that is, calling the police. If the law states that camping on public land requires a license from a county clerk, the clerk has to draft a camping license form, then once citizen has completed the filing, collect it and any necessary fee, and then provide a receipt to citizen. If the county wishes to computerize the above process and have licenses (or filing documents) processed by a smartphone or a computer application, there is an additional step, that is, a programmer has to take convert the clerk's filing document paperwork into a computer readable language to build an application for the user to interface with. Currently, such an application is coded in a computer language (such as JavaScript) by the programmer based on paper filing document written in a human language (such as English) by a government employee, who in turn bases it on legislative language (which authorizes but seldom specifies the details of filing documents) that is enacted lawmakers. As a consequence, the intent of the elected officials who write the laws of man is very often lost in translation.

To analogize this to the childhood game of telephone, the county commission's enacted law is first spoken to the county clerk, who then repeats it to the computer programmer, who then repeats it to the citizen, who wishes to obey the law. However, this analogy understates the problems of the current state of the art. Even if each step has translated legislative intent perfectly, since different (in both jurisdictional and temporal sense) elected bodies delegate authority to difference government employees who hire different computer programmers, even a conscientious citizen who is computer literate faces the confusion of a new user interface design—a new alphabet, in a sense—with every new government filing computer application.

Therefore, there is a need for methods and systems to draft legislation and simplify the system of governance in a transparent, simple, and efficient fashion.

### SUMMARY OF THE INVENTION

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

Disclosed is a computer method of facilitating drafting of legislation. The computer-implemented method include receiving, using a communication device, a subject indicator from a legislator device, wherein the subject indicator corresponds to a legislation. Further, the method includes analyzing, using a processing device, the subject indicator. Yet further, the method includes retrieving, using the processing device, a plurality of suggested legal constructs from a storage device based on the analyzing of the subject indicator. Further, the method includes transmitting, using the communication device, the plurality of suggested legal constructs to the legislator device, wherein the legislator device is configured for presenting the plurality of suggested legal constructs. Moreover, the method includes receiving, using the communication device, a plurality of selected legal constructs from the legislator device, wherein the plurality of selected legal constructs is based on the plurality of suggested legal constructs. Further, the method includes analyzing, using the processing device, the plurality of selected legal constructs based on a plurality of rules. Yet further, the method includes generating, using the processing device, at least one suggested legislation based on the analyzing of the plurality of selected legal constructs. Further, the method includes storing the at least one suggested legislation in the storage device. Moreover, the method includes transmitting, using the communication device, the at least one suggested legislation to the legislator device.

According to some aspects, a system for facilitating drafting of legislation is disclosed. The system in includes a communication device configured for receiving a subject indicator from a legislator device, wherein the subject indicator corresponds to a legislation. Further, the communication device is configured for transmitting a plurality of suggested legal constructs to the legislator device, wherein the legislator device is configured for presenting the plurality of suggested legal constructs. Yet further, a communication device configured for receiving a plurality of selected legal constructs from the legislator device, wherein the plurality of selected legal constructs is based on the plurality of suggested legal constructs. Moreover, the communication device configured for transmitting at least one suggested legislation to the legislator device. The system further includes a processing device configured for analyzing the subject indicator and retrieving the plurality of suggested legal constructs based on the analyzing of the subject indicator. Further, the processing device configured for analyzing the plurality of selected legal constructs based on a plurality of rules and generating the at least one suggested legislation based on the analyzing of the plurality of selected legal constructs. Moreover, the system includes a storage device configured for storing the plurality of suggested legal constructs and the at least one suggested legislation.

According to some aspects, the use of the disclosed system and method allows for simple and time-efficient coding and editing of application software, even by elected legislators who are unskilled in computer programming, that may also function as a legislative language that can be debated, enacted and enforced as law.

According to some aspects, a software application created (that is, enacted into law) for a particular filing document may comprise of different standardized cards each of a common template and design, easily adaptable to other agencies with similar application needs and easily amendable in the future by lawmakers.

According to some aspects, a uniform codebook may be developed, which may be in the form of a publicly accessible database. The uniform code book may contain sections or modules that lawmakers can adopt by reference and containing, as well, appendices where specific code provisions relevant to particular state or localities are available. The codebook publisher may cooperate with particular jurisdictions to tailor an existing uniform codebook section to suit their particular needs. Alternately, lawmakers may code the sections themselves since legislative and computer code draftsmanship would be in the same language and could be accomplished at the same time.

According to some aspects, the disclosed system allows a legislative body to create an application (may be a computer software and a filing document) that a citizen may fill out electronically and send to a specified agency, whose server processes it instantly and immediately acknowledges receipt, with no further action required.

According to some aspects, the disclosed system and method could be harnessed to transform lawmaking (in a way not seen since Napoleon codified the laws of France). The use of code that is both human and machine-readable and the use of a common user interface design across levels of government would bring efficiency, transparency, and user-friendliness to both lawmaking and law enforcement.

According to some aspects, the disclosed system may assist lawmakers in foreign governments whose laws and language may differ considerably.

According to some aspects, the disclosed system allows lawmakers to draft legislation in a legal and computer language readable method by both laymen and machines. Therefore, the legislation language itself may be used to create applications for citizen use, by means of standardized cards written in a legal and computer language readable by both laymen and machines. The use of standardized cards means that all lawmaking bodies (whether local, state or federal) that adopt the disclosed system would have a common user interface design. Likewise, any changes in legislative policy over time may simply mean amending the standardized cards. Thus, the use of a standard design may minimize citizen confusion in learning to use new software by making different government filings conform to a consistent pattern. On the part of the legislative body, the use of the present disclosure allows for the regulatory law to be written in the form that it is typically enforced, by the drafting of a government filing document (with appropriate administrative, civil monetary, equitable or criminal consequences for false and nonexistent filings). This puts the discretion of the specific terms and requirements of the laws which constrain citizens where it belongs, that is in the hands of those elected to serve and not outsourced to unelected government managers or the computer programmers they hire.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 illustrates an exemplary environment in which embodiments of the present disclosure may be implemented.

FIG. 2 illustrates a block diagram of a system for facilitating drafting of legislation in accordance with some embodiments.

FIG. 3 illustrates a flowchart of a method for facilitating drafting of legislation in accordance with some embodiments.

FIG. 4 illustrates an exemplary computing system that may be employed to implement processing functionality for various embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.” The following detailed description refers to the accompanying drawings.

Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of drafting legislation, embodiments of the present disclosure are not limited to use only in this context. For example, the disclosed techniques may be used to rank other items that given out for rent or sale.

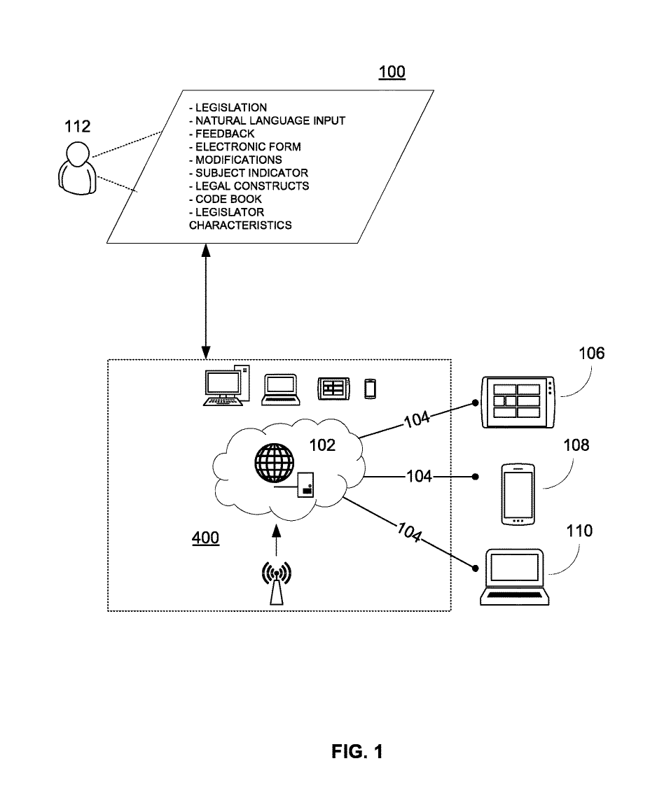

FIG. 1 is an illustration of a platform consistent with various embodiments of the present disclosure. By way of non-limiting example, the online platform 100 for facilitating drafting of legislation may be hosted on a centralized server 102, such as, for example, a cloud computing service. The centralized server 102 may communicate with other network entities, such as, for example, a mobile device (such as a smartphone, a laptop, a tablet computer etc.) and other electronic devices (such as desktop computers, etc.) over a communication network 104, such as, but not limited to, the Internet. Further, users of the platform may include one or more relevant parties such as, legislators, government agency employees, and citizens. Accordingly, electronic devices operated by the one or more relevant parties may be in communication with the platform. For example, the platform may be in communication with a legislator electronic device 106 operated by the legislator, an agency employee electronic device 108 operated by the agency employee and a citizen electronic device 110 operated by the citizen.

A user 112, such as the one or more relevant parties, may access platform 100 through a software application. The software application may be embodied as, for example, but not be limited to, a website, a web application, a desktop application, and a mobile application compatible with a computing device 400. Accordingly, in an instance, the user 112 may be a legislator who may draft a law, a government agency employee who may provide requirements for a new electronic form, and a citizen who may access an electronic form.

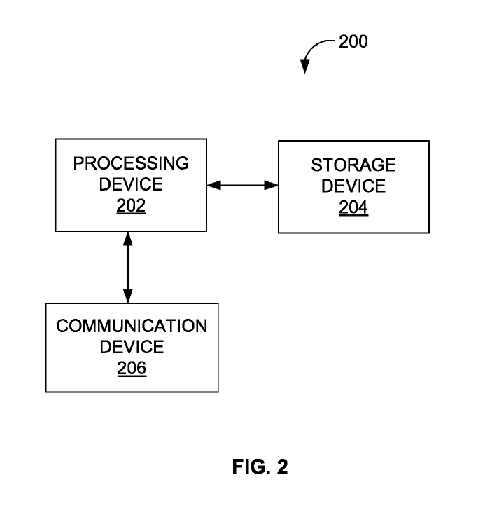

Turning to FIG. 2, a system 200 for facilitating drafting of legislation is illustrated, in accordance with some embodiments. As shown, the system 200 includes a communication device 202, a processing device 204 and a storage device 206.

The communication device 202 may be configured to receive a subject indicator from a legislator device, wherein the subject indicator may correspond to a legislation. For example, the subject indicator may relate to a specific domain or sub-domain of law, such as, but not limited to, antitrust law, aviation law, banking law, business law, communications law, computer law, contract law, copyright law, corporate law, criminal law, employment law, energy law, health law, immigration law, martial law, media law, medical law, patent law, privacy law, real estate law, tax law, technology law, tort law and trademark law. Further, the subject indicator may include a natural language input representing one or more purposes of the legislation. Accordingly, the processing device 204 may be configured to analyze the subject indicator. For example, the analysis may include the subject indicator with a list of tags.

Further, the processing device 204 may be configured to retrieve multiple suggested legal constructs based on the analyzing of the subject indicator. Accordingly, the communication device 202 may be configured to transmit multiple suggested legal constructs to the legislator device (similar to the legislator electronic device 106). The legislator device may be configured for presenting the multiple suggested legal constructs. The legal constructs may be retrieved from a code book. The legal constructs may relate to specific snippets from previously drafted laws within or outside the country, state, county, or city. The snippets may include clauses, paragraphs, provisions, exceptions, and sections of previously drafted laws. Further, the snippets may be used as modular units.

In further embodiments, the communication device 202 may be further configured to receive one or more characteristics of a legislator account associated with the legislator device, wherein the processing device 204 may be further configured to receive the multiple selected legal constructs further based on the one or more characteristics of the legislator account. For example, the one or more characteristics may include jurisdiction, authority, and domain. Accordingly, the legal constructs may be automatically filtered based on the one or more characteristics of the legislator account.

Yet further, the communication device 202 may be configured to receive multiple selected legal constructs from the legislator device. The multiple selected legal constructs may be based on the multiple suggested legal constructs. Therefore, the legislator (using the legislator device) may select the multiple selected legal constructs from the multiple suggested legal constructs.

Further, the processing device 204 may be configured to analyze the multiple selected legal constructs based on multiple rules and generating the one or more suggested legislations based on the analyzing of the multiple selected legal constructs. For example, the multiple rules may determine what legal constructs are combinable with what other legal constructs and the manner in which they may be combined to form a legislation.

The storage device 206 may be configured to store the multiple suggested legal constructs and the one or more suggested legislations. Moreover, the communication device 202 may be configured to transmit one or more suggested legislations to the legislator device.

In further embodiments, the legislator may make one or more modifications to one or more of the multiple suggested legal constructs. Accordingly, the multiple selected legal constructs may be based on one or more modifications to one or more of the multiple suggested legal constructs, wherein the one or more modifications may be received by the legislator device. Further, the storage device 206 may be further configured for storing one or more modified legal constructs based on the one or more modifications. The legislator (or other legislators) may access the stored modified legal constructs for later use.

In further embodiments, the multiple selected legal constructs may include a first selected legal construct selected based on a first selection and a second selected legal construct selected based on a second selection, wherein the processing device 204 may be further configured to modify the first selected legal construct based on the second selection, wherein the communication device 202 may be further configured to transmit a modified first selected legal construct to the legislator device, wherein the modified first selected legal construct is based on the modifying. Accordingly, the selected first legal construct may be automatically adapted based on a subsequently selected second legal construct in order to enable a proper combination of the two legal constructs to form the legislation.

In further embodiments, the processing device 204 may be further configured to detect one or more legal issues based on the analyzing of the multiple selected legal constructs, wherein the communication device 202 may be further configured to transmit one or more warnings to the legislator device based on the detecting. The one or more warnings may include an indication of the one or more legal issues. For example, the detecting may be based on rules (such as syntactic and semantic rules) to determine whether there are any inaccuracies, inconsistencies, ambiguities, redundancies, and contradictions. Further, the rules may also detect legal loop-holes.

In further embodiments, an electronic form may be automatically generated based on analyzing the one or more suggested legislations. Accordingly, the processing device 204 may be further configured to analyze the one or more suggested legislations. The analysis may include identifying each of a requested data and a presented data. For example, the requested data may be related to one or more input fields in the electronic form and the presented data may be related to instructions provided in the electronic form. Further, the processing device 204 may be configured to generate an electronic form based on the analyzing of the one or more suggested legislations, wherein the electronic form may include an input field configured to receive the requested data and an output field configured to present the presented data. Yet further, the processing device 204 may be configured to process the electronic form based on a feedback, wherein the communication device 202 may be further configured to transmit the electronic form to a builder device (similar to the legislator device) and receiving the feedback corresponding to the electronic form from the builder device. The feedback may include a confirmation or a modification to the electronic form.

In further embodiments, the system 200 may be used to amend existing laws. Accordingly, the communication device 202 may be further configured for receiving an existing legislation, wherein the processing device 204 may be further configured to analyze each of the existing legislation and the one or more suggested legislations. Further, the processing device 204 may be configured to generate an amended legislation based on the analyzing of each of the existing legislation and one or more suggested legislations.

In further embodiments, existing legislation may be analyzed in view of the suggested legislation in order to detect issues. Accordingly, the communication device 202 may be further configured to receive an existing legislation and transmit one or more warnings to the legislator device based on the detecting of the one or more legal issues (such as, conflicts, redundancies, and ambiguities) The one or more warnings may include indication of the one or more legal issues, wherein the processing device 204 may be further configured to analyze each of the existing legislation and one or more suggested legislations and detect one or more legal issues based on the analyzing of the existing legislation and the one or more suggested legislations.

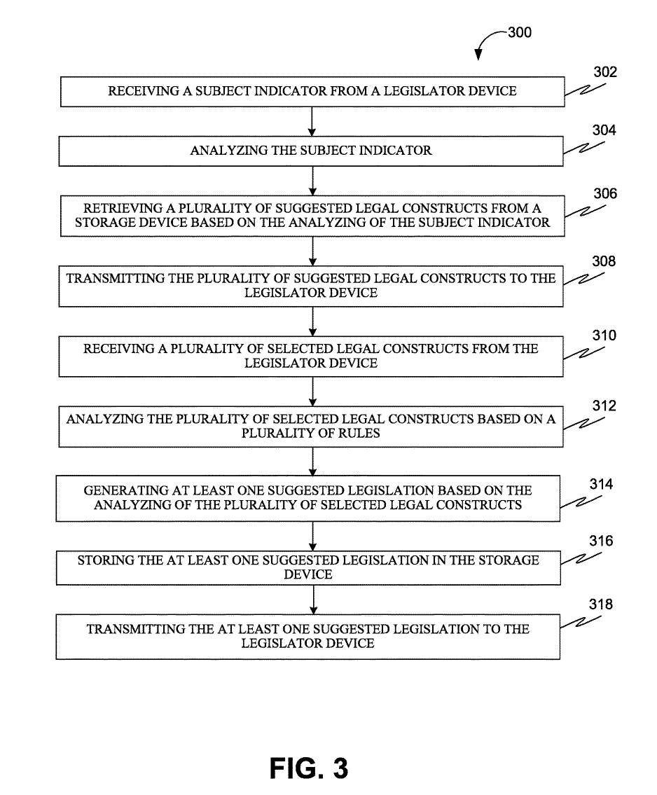

FIG. 3 illustrates a flowchart of a method 300 for facilitating drafting of legislation, in accordance with some embodiments. At 302, the method 300 includes receiving, using a communication device (such as the communication device 202), a subject indicator from a legislator device (such as the legislator electronic device 106). The subject indicator may correspond to a legislation. The subject indicator may relate to a specific domain or sub-domain of law. The subject indicator may include a natural language input representing one or more purposes of the legislation.

At 304, the method 300 includes analyzing, using a processing device (such as the processing device 204), the subject indicator. The analyzing may include the subject indicator with a list of tags. Then, at 306, the method 300 includes retrieving, using the processing device, multiple suggested legal constructs from a storage device (such as the storage device 206) based on the analyzing of the subject indicator.

At 308, the method 300 includes transmitting, using the communication device, the multiple suggested legal constructs to the legislator device. The legislator device may be configured for presenting the multiple suggested legal constructs.

At 310, the method 300 includes receiving, using the communication device, multiple selected legal constructs from the legislator device. The multiple selected legal constructs may be based on the multiple suggested legal constructs.

At 312, the method 300 includes analyzing, using the processing device, the multiple selected legal constructs based on multiple rules. For example, the rules may determine what legal constructs are combinable with what other legal constructs and the manner in which they may be combined to form a legislation.

At 314, the method 300 includes generating, using the processing device, one or more suggested legislations based on the analyzing of the multiple selected legal constructs. Then, at 316, the method 300 includes storing the one or more suggested legislations in the storage device. At 318, the method 300 includes transmitting, using the communication device, the one or more suggested legislations to the legislator device.

In some embodiments, the multiple selected legal constructs may be based on one or more modifications to one or more of the multiple suggested legal constructs. The one or more modifications may be received by the legislator device. Further, the method 300 may include storing one or more modified legal constructs in the storage device based on the one or more modifications.

In further embodiments, the method 300 may include receiving, using the communication device, one or more characteristics of a legislator account associated with the legislator device, wherein the retrieving of the multiple selected legal constructs may be further based on the one or more characteristics of the legislator account. For example, the one or more characteristics of the legislator account may include jurisdiction, authority, and domain of the legislator. Accordingly, the legal constructs may be auto-filtered based on the one or more characteristics.

In further embodiments, the multiple selected legal constructs include a first selected legal construct selected based on a first selection and a second selected legal construct selected based on a second selection. Accordingly, the method 300 may further include modifying, using the processing device, the first selected legal construct based on the second selection and transmitting, using the communication device, a modified first selected legal construct to the legislator device. The modified first selected legal construct may be based on the modifying. Accordingly, the first legal construct may be automatically adapted based on a subsequently selected second legal construct in order to enable a proper combination of the two legal constructs to form the legislation.

In further embodiments, the method 300 includes detecting, using the processing device one or more legal issues based on the analyzing of the multiple selected legal constructs. The detecting may be based on rules to determine whether there are any inaccuracies, inconsistencies, ambiguities, redundancies, and contradictions. In some embodiments, the rules may also detect legal loop-holes. The method 300 also includes transmitting, using the communication device, one or more warnings to the legislator device based on the detecting, wherein the one or more warnings comprises an indication of the one or more legal issues.

In further embodiments, an electronic form may be automatically generated based on analyzing legislation. Accordingly, the method 300 includes analyzing, using the processing device, the one or more suggested legislations, wherein the analyzing comprises identifying each of a requested data and a presented data. Further, the method 300 includes generating, using the processing device, an electronic form based on the analyzing of the one or more suggested legislations, wherein the electronic form comprises an input field configured to receive the requested data and an output field configured to present the presented data. Yet further, the method 300 includes transmitting, using the communication device, the electronic form to a builder device (such as the legislator device). Further, the method 300 includes receiving, using the communication device, a feedback corresponding to the electronic form from the builder device. The feedback may include a confirmation and/or a modification to the electronic form. Moreover, the method 300 includes processing, using the processing device, the electronic form based on the feedback.

In further embodiments, the existing legislation may be amended by the method 300. Accordingly, the method 300 includes receiving, using the communication device, an existing legislation, analyzing, using the processing device, each of the existing legislation and the one or more suggested legislations and generating, using the processing device, an amended legislation based on the analyzing of each of the existing legislation and the one or more suggested legislations.

In further embodiments, the method 300 includes receiving, using the communication device, an existing legislation and analyzing, using the processing device, each of the existing legislation and the one or more suggested legislations. Further, the method 300 includes detecting, using the processing device one or more legal issues based on the analyzing of the existing legislation and the one or more suggested legislations. Moreover, the method 300 includes transmitting, using the communication device, one or more warnings to the legislator device based on the detecting of the one or more legal issues, wherein the one or more warnings comprises an indication of the one or more legal issues. Accordingly, existing legislation may be analyzed in view of the suggested legislation in order to detect issues (such as conflicts, redundancies, and ambiguities).

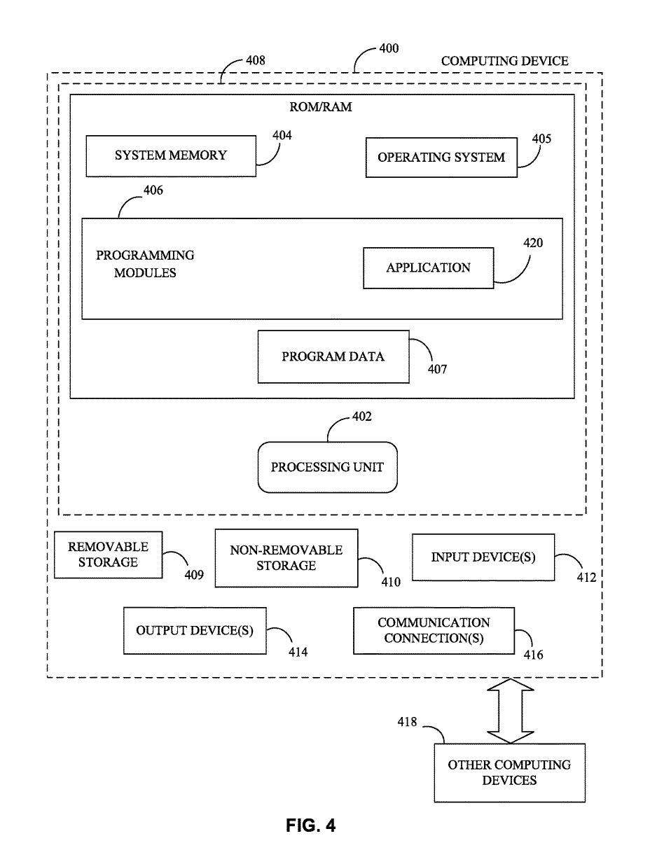

FIG. 4 is a block diagram of a system including computing device 400. Consistent with an embodiment of the disclosure, the aforementioned storage device and processing device may be implemented in a computing device, such as computing device 400 of FIG. 4. Any suitable combination of hardware, software, or firmware may be used to implement the memory storage and processing unit. For example, the storage device and the processing device may be implemented with computing device 400 or any of other computing devices 418, in combination with computing device 400. The aforementioned system, device, and processors are examples and other systems, devices, and processors may comprise the aforementioned storage device and processing device, consistent with embodiments of the disclosure.

With reference to FIG. 4, a system consistent with an embodiment of the disclosure may include a computing device or cloud service, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination. System memory 404 may include operating system 405, one or more programming modules 406, and may include a program data 407. Operating system 405, for example, may be suitable for controlling computing device 400's operation. In one embodiment, programming modules 406 may include image encoding module, machine learning module and image classifying module. Furthermore, embodiments of the disclosure may be practiced in conjunction with a graphics library, other operating systems, or any other application program and is not limited to any particular application or system. This basic configuration is illustrated in FIG. 4 by those components within a dashed line 408.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer-readable instructions, data structures, program modules, or other data. System memory 404, removable storage 409, and non-removable storage 410 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a touch input device, etc. Output device(s) 414 such as a display, speakers, a printer, etc. may also be included. The aforementioned devices are examples and others may be used.

Computing device 400 may also contain a communication connection 416 that may allow device 400 to communicate with other computing devices 418, such as over a network in a distributed computing environment, for example, an intranet or the Internet. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 404, including operating system 405. While executing on processing unit 402, programming modules 406 (e.g., application 420) may perform processes including, for example, one or more stages of method 300 as described above. The aforementioned process is an example, and processing unit 402 may perform other processes. Other programming modules that may be used in accordance with embodiments of the present disclosure may include image encoding applications, machine learning application, image classifiers etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

### DETAIL DESCRIPTIONS OF THE EMBODIMENTS

A computer method of facilitating drafting of legislation is provided. The computer-implemented method may include receiving, using a communication device, a subject indicator from a legislator device. Further, the subject indicator corresponds to a legislation. Further, the computer-implemented method may include analyzing, using a processing device, the subject indicator. Further, the computer-implemented method may include retrieving, using the processing device, a plurality of suggested legal constructs from a storage device based on the analyzing of the subject indicator. Further, the computer-implemented method may include transmitting, using the communication device, the plurality of suggested legal constructs to the legislator device. Further, the legislator device may be configured for presenting the plurality of suggested legal constructs. Further, the computer-implemented method may include receiving, using the communication device, a plurality of selected legal constructs from the legislator device. Further, the plurality of selected legal constructs may be based on the plurality of suggested legal constructs. Further, the computer-implemented method may include analyzing, using the processing device, the plurality of selected legal constructs based on a plurality of rules. Further, the computer-implemented method may include generating, using the processing device, at least one suggested legislation based on the analyzing of the plurality of selected legal constructs. Further, the computer-implemented method may include storing the at least one suggested legislation in the storage device. Further, the computer-implemented method may include transmitting, using the communication device, the at least one suggested legislation to the legislator device.

In some embodiments, the plurality of selected legal constructs may be based on at least one modification to one or more of the plurality of suggested legal constructs. Further, the at least one modification may be received by the legislator device.

In some embodiments, the computer-implemented method may further include storing at least one modified legal construct in the storage device based on the at least one modification.

In some embodiments, the computer-implemented method may further include receiving, using the communication device, at least one characteristic of a legislator account associated with the legislator device. Further, the retrieving of the plurality of selected legal constructs may be further based on the at least one characteristic of the legislator account.

In some embodiments, the subject indicator may include a natural language input representing at least one purpose of the legislation.

In some embodiments, the plurality of selected legal constructs may include a first selected legal construct selected based on a first selection and a second selected legal construct selected based on a second selection. Further, the method further comprises: modifying, using the processing device, the first selected legal construct based on the second selection; and transmitting, using the communication device, a modified first selected legal construct to the legislator device. Further, the modified first selected legal construct may be based on the modifying.

In some embodiments, the computer-implemented method may further include: detecting, using the processing device at least one legal issue based on the analyzing of the plurality of selected legal constructs; and transmitting, using the communication device, at least one warning to the legislator device based on the detecting. Further, the at least one warning may include indication of the at least one legal issue.

In some embodiments, the computer-implemented may further include: analyzing, using the processing device, the at least one suggested legislation. Further, the analyzing may include identifying each of a requested data and a presented data; generating, using the processing device, an electronic form based on the analyzing of the at least one suggested legislation. Further, the electronic form may include an input field configured to receive the requested data and an output field configured to present the presented data; transmitting, using the communication device, the electronic form to a builder device; receiving, using the communication device, a feedback corresponding to the electronic form from the builder device; and processing, using the processing device, the electronic form based on the feedback.

In some embodiments, the computer-implemented method may further include: receiving, using the communication device, an existing legislation; analyzing, using the processing device, each of the existing legislation and the at least one suggested legislation; and generating, using the processing device, an amended legislation based on the analyzing of each of the existing legislation and the at least one suggested legislation.

In some embodiments, the computer-implemented method may further include: receiving, using the communication device, an existing legislation; analyzing, using the processing device, each of the existing legislation and the at least one suggested legislation; detecting, using the processing device at least one legal issue based on the analyzing of the existing legislation and the at least one suggested legislation; and transmitting, using the communication device, at least one warning to the legislator device based on the detecting of the at least one legal issue. Further, the at least one warning may include indication of the at least one legal issue.

Further, a system for facilitating drafting of legislation is provided. The system may include a communication device configured for: receiving a subject indicator from a legislator device. Further, the subject indicator corresponds to a legislation. Further, the communication device may be configured for transmitting a plurality of suggested legal constructs to the legislator device. Further, the legislator device may be configured for presenting the plurality of suggested legal constructs. Further, the system may include receiving a plurality of selected legal constructs from the legislator device. Further, the plurality of selected legal constructs may be based on the plurality of suggested legal constructs. Further, the communication device may be configured for transmitting at least one suggested legislation to the legislator device. Further, the system may include a processing device configured for analyzing the subject indicator. Further, the processing device may be configured for retrieving the plurality of suggested legal constructs based on the analyzing of the subject indicator. Further, the processing device may be configured for analyzing the plurality of selected legal constructs based on a plurality of rules. Further, the processing device may be configured for generating the at least one suggested legislation based on the analyzing of the plurality of selected legal constructs. Further, the system may include a storage device configured for storing the plurality of suggested legal constructs and the at least one suggested legislation.

In some embodiments, the plurality of selected legal constructs may be based on at least one modification to one or more of the plurality of suggested legal constructs. Further, the at least one modification may be received by the legislator device.

In some embodiments, the storage device may be further configured for storing at least one modified legal construct based on the at least one modification.

In some embodiments, the communication device may be further configured for receiving at least one characteristic of a legislator account associated with the legislator device. Further, the processing device may be further configured for retrieving the plurality of selected legal constructs further based on the at least one characteristic of the legislator account.

In some embodiments, the subject indicator may include a natural language input representing at least one purpose of the legislation.

In some embodiments, the plurality of selected legal constructs may include a first selected legal construct selected based on a first selection and a second selected legal construct selected based on a second selection. Further, the processing device may be further configured for modifying the first selected legal construct based on the second selection. Further, the communication device may be further configured for transmitting a modified first selected legal construct to the legislator device. Further, the modified first selected legal construct may be based on the modifying.

In some embodiments, the processing device may be further configured for detecting at least one legal issue based on the analyzing of the plurality of selected legal constructs. Further, the communication device may be further configured for transmitting at least one warning to the legislator device based on the detecting. Further, the at least one warning may include indication of the at least one legal issue.

In some embodiments, the processing device may be further configured for: analyzing the at least one suggested legislation. Further, the analyzing may include identifying each of a requested data and a presented data; generating an electronic form based on the analyzing of the at least one suggested legislation. Further, the electronic form may include an input field configured to receive the requested data and an output field configured to present the presented data; and processing the electronic form based on a feedback. Further, the communication device may be further configured for: transmitting the electronic form to a builder device; and receiving the feedback corresponding to the electronic form from the builder device.

In some embodiments, the communication device may be further configured for receiving an existing legislation. Further, the processing device may be further configured for: analyzing each of the existing legislation and the at least one suggested legislation; and generating an amended legislation based on the analyzing of each of the existing legislation and the at least one suggested legislation.

In some embodiments, the communication device may be further configured for: receiving an existing legislation; and transmitting at least one warning to the legislator device based on the detecting of the at least one legal issue. Further, the at least one warning may include indication of the at least one legal issue. Further, the processing device may be further configured for: analyzing each of the existing legislation and the at least one suggested legislation; and detecting at least one legal issue based on the analyzing of the existing legislation and the at least one suggested legislation.

Although the invention has been explained in relation to its preferred embodiment, it is to be understood that many other possible modifications and variations can be made without departing from the spirit and scope of the invention.

I/We claim:

1. A computer method of facilitating drafting of legislation, the computer-implemented method comprising:
receiving, using a communication device, a subject indicator from a legislator device, wherein the subject indicator corresponds to a legislation;
analyzing, using a processing device, the subject indicator;
retrieving, using the processing device, a plurality of suggested legal constructs from a storage device based on the analyzing of the subject indicator;
transmitting, using the communication device, the plurality of suggested legal constructs to the legislator device, wherein the legislator device is configured for presenting the plurality of suggested legal constructs;
receiving, using the communication device, a plurality of selected legal constructs from the legislator device, wherein the plurality of selected legal constructs is based on the plurality of suggested legal constructs;
analyzing, using the processing device, the plurality of selected legal constructs based on a plurality of rules;
generating, using the processing device, at least one suggested legislation based on the analyzing of the plurality of selected legal constructs;
storing the at least one suggested legislation in the storage device; and
transmitting, using the communication device, the at least one suggested legislation to the legislator device.

2. The computer-implemented method of claim 1, wherein the plurality of selected legal constructs is based on at least one modification to at least one of the plurality of suggested legal constructs, wherein the at least one modification is received by the legislator device.

3. The computer-implemented method of claim 2 further comprising storing at least one modified legal construct in the storage device based on the at least one modification.

4. The computer-implemented method of claim 1 further comprising receiving, using the communication device, at least one characteristic of a legislator account associated with the legislator device, wherein the retrieving of the plurality of selected legal constructs is further based on the at least one characteristic of the legislator account.

5. The computer-implemented method of claim 1, wherein the subject indicator comprises a natural language input representing at least one purpose of the legislation.

6. The computer-implemented method of claim 1, wherein the plurality of selected legal constructs comprises a first selected legal construct selected based on a first selection and a second selected legal construct selected based on a second selection, wherein the method further comprises:
modifying, using the processing device, the first selected legal construct based on the second selection; and
transmitting, using the communication device, a modified first selected legal construct to the legislator device, wherein the modified first selected legal construct is based on the modifying.

7. The computer-implemented method of claim 1 further comprising:
detecting, using the processing device at least one legal issue based on the analyzing of the plurality of selected legal constructs; and
transmitting, using the communication device, at least one warning to the legislator device based on the detecting, wherein the at least one warning comprises indication of the at least one legal issue.

8. The computer-implemented of claim 1 further comprising:
analyzing, using the processing device, the at least one suggested legislation, wherein the analyzing comprises identifying each of a requested data and a presented data;
generating, using the processing device, an electronic form based on the analyzing of the at least one suggested legislation, wherein the electronic form comprises an input field configured to receive the requested data and an output field configured to present the presented data;
transmitting, using the communication device, the electronic form to a builder device;
receiving, using the communication device, a feedback corresponding to the electronic form from the builder device; and
processing, using the processing device, the electronic form based on the feedback.

9. The computer-implemented method of claim 1 further comprising:
receiving, using the communication device, an existing legislation;
analyzing, using the processing device, each of the existing legislation and the at least one suggested legislation; and
generating, using the processing device, an amended legislation based on the analyzing of each of the existing legislation and the at least one suggested legislation.

10. The computer-implemented method of claim 1 further comprising:
receiving, using the communication device, an existing legislation;
analyzing, using the processing device, each of the existing legislation and the at least one suggested legislation;
detecting, using the processing device at least one legal issue based on the analyzing of the existing legislation and the at least one suggested legislation; and
transmitting, using the communication device, at least one warning to the legislator device based on the detecting of the at least one legal issue, wherein the at least one warning comprises indication of the at least one legal issue.

11. A system for facilitating drafting of legislation, the system comprising:
a communication device configured for:
receiving a subject indicator from a legislator device, wherein the subject indicator corresponds to a legislation;
transmitting a plurality of suggested legal constructs to the legislator device, wherein the legislator device is configured for presenting the plurality of suggested legal constructs;
receiving a plurality of selected legal constructs from the legislator device, wherein the plurality of selected legal constructs is based on the plurality of suggested legal constructs; and
transmitting at least one suggested legislation to the legislator device;
a processing device configured for:
analyzing the subject indicator;
retrieving the plurality of suggested legal constructs based on the analyzing of the subject indicator;
analyzing the plurality of selected legal constructs based on a plurality of rules; and
generating the at least one suggested legislation based on the analyzing of the plurality of selected legal constructs; and
a storage device configured for storing the plurality of suggested legal constructs and the at least one suggested legislation.

12. The system of claim 11, wherein the plurality of selected legal constructs is based on at least one modification to at least one of the plurality of suggested legal constructs, wherein the at least one modification is received by the legislator device.

13. The system of claim 12, wherein the storage device is further configured for storing at least one modified legal construct based on the at least one modification.

14. The system of claim 11, wherein the communication device is further configured for receiving at least one characteristic of a legislator account associated with the legislator device, wherein the processing device is further configured for retrieving the plurality of selected legal constructs further based on the at least one characteristic of the legislator account.

15. The system of claim 11, wherein the subject indicator comprises a natural language input representing at least one purpose of the legislation.

16. The system of claim 11, wherein the plurality of selected legal constructs comprises a first selected legal construct selected based on a first selection and a second selected legal construct selected based on a second selection, wherein the processing device is further configured for modifying the first selected legal construct based on the second selection, wherein the communication device is further configured for transmitting a modified first selected legal construct to the legislator device, wherein the modified first selected legal construct is based on the modifying.

17. The system of claim 11, wherein the processing device is further configured for detecting at least one legal issue based on the analyzing of the plurality of selected legal constructs, wherein the communication device is further configured for transmitting at least one warning to the legislator device based on the detecting, wherein the at least one warning comprises indication of the at least one legal issue.

18. The computer-implemented of claim 11, wherein the processing device is further configured for:
analyzing the at least one suggested legislation, wherein the analyzing comprises identifying each of a requested data and a presented data;
generating an electronic form based on the analyzing of the at least one suggested legislation, wherein the electronic form comprises an input field configured to receive the requested data and an output field configured to present the presented data; and
processing the electronic form based on a feedback, wherein the communication device is further configured for:
transmitting the electronic form to a builder device; and
receiving the feedback corresponding to the electronic form from the builder device.

19. The system of claim 11, wherein the communication device is further configured for receiving an existing legislation, wherein the processing device is further configured for:
analyzing each of the existing legislation and the at least one suggested legislation; and
generating an amended legislation based on the analyzing of each of the existing legislation and the at least one suggested legislation.

20. The system of claim 11, wherein the communication device is further configured for:
receiving an existing legislation; and
transmitting at least one warning to the legislator device based on the detecting of the at least one legal issue, wherein the at least one warning comprises indication of the at least one legal issue, wherein the processing device is further configured for:
analyzing each of the existing legislation and the at least one suggested legislation; and
detecting at least one legal issue based on the analyzing of the existing legislation and the at least one suggested legislation.
